(19) United States
(12) Patent Application Publication
(10) Pub. No.: US 2026/0320132 A1
(43) Pub. Date: Oct. 15, 2026

(54) FAILURE FACTOR ANALYSIS SUPPORT SYSTEM, FAILURE FACTOR ANALYSIS SUPPORT METHOD, AND PROGRAM

(71) Applicant: Panasonic Intellectual Property Management Co., Ltd., Osaka (JP)

(72) Inventor: MOTOTAKA KABASHIMA, Osaka (JP)

(21) Appl. No.: 19/635,892

(22) Filed: Apr. 1, 2026

(30) Foreign Application Priority Data
Apr. 10, 2025 (JP) 2025-064999

(51) Int. Cl. G06F 16/904; G06F 16/22; G06F 16/901; G06F 18/22; G06F 40/30

(52) U.S. Cl. CPC G06F 16/904; G06F 16/2237; G06F 16/9024; G06F 18/22; G06F 40/30

(57) ABSTRACT

A failure factor analysis support system includes a text search unit that searches for a text necessary for failure factor analysis of an object from a predetermined database group, and a failure factor generation unit that generates a first failure factor analysis table based on a search result of the text search unit. The predetermined database group includes a vector database and a graph database. The vector database is a database including a latent variable obtained by converting text data. The graph database is a database including, as a graph structure, a correspondence between first character strings each including a word of a general expression, a correspondence between second character strings each including a word of a specific expression, and a correspondence between the first character string and the second character string in text data.

### BACKGROUND

### 1. Technical Field

The present disclosure relates to a failure factor analysis support system, a failure factor analysis support method, and a program.

### 2. Description of the Related Art

Conventionally, failure mode and effects analysis (FMEA) and the like are known as an analysis method for previously identifying and analyzing a failure (failure mode) that may occur in a product or a production process. In the FMEA, completeness in advance examination of failure modes is important. PTL 1 discloses a system that extracts a maintenance history as a failure analysis target from a maintenance history database without omission.

### CITATION LIST

### Patent Literature

PTL 1: Unexamined Japanese Patent Publication No. 2024-174562

### SUMMARY

A failure factor analysis support system according to an aspect of the present disclosure includes a text search unit that searches for a text necessary for failure factor analysis of an object from a predetermined database group, and a failure factor generation unit that generates a first failure factor analysis table based on a search result of the text search unit, in which the predetermined database group includes a vector database and a graph database, the vector database is a database including a latent variable obtained by converting text data, and the graph database is a database including, as a graph structure, a correspondence between first character strings each including a word of a general expression, a correspondence between second character strings each including a word of a specific expression, and a correspondence between the first character string and the second character string in text data.

A failure factor analysis support method performed by a processor according to one aspect of the present disclosure includes searching for a text necessary for failure factor analysis of an object from a predetermined database group, and generating a failure factor analysis table based on a search result, in which the predetermined database group includes a vector database and a graph database, the vector database is a database including a latent variable obtained by converting text data, and the graph database is a database including, as a graph structure, a correspondence between first character strings each including a word of a general expression, a correspondence between second character strings each including a word of a specific expression, and a correspondence between the first character string and the second character string in text data.

A program according to one aspect of the present disclosure is a program for causing a computer to execute the failure factor analysis support method.

### BRIEF DESCRIPTION OF THE DRAWINGS

FIG. 1 is a diagram illustrating a configuration of a failure factor analysis support system according to an exemplary embodiment;

FIG. 2 is a flowchart illustrating a first operation of the failure factor analysis support system according to the exemplary embodiment;

FIG. 3 is a diagram illustrating an FMEA table in the middle of being generated by a user;

FIG. 4 is an image diagram of a latent variable space according to the exemplary embodiment;

FIG. 5 is a diagram illustrating a display example in which a search result according to the exemplary embodiment is reflected;

FIG. 6 is a flowchart illustrating a second operation of the failure factor analysis support system according to the exemplary embodiment;

FIG. 7 is a diagram for explaining the granularity according to the exemplary embodiment;

FIG. 8 is a flowchart illustrating an operation of automatically generating an FMEA table according to a modification of the exemplary embodiment; and

FIG. 9 is a flowchart illustrating an operation of each task according to a modification of the exemplary embodiment.

### DETAILED DESCRIPTIONS

Incidentally, it is desirable that a failure factor analysis table generated using an analysis method such as FMEA be generated more accurately.

Therefore, the present disclosure provides a failure factor analysis support system and the like that can support generation of a more accurate failure factor analysis table.

A failure factor analysis support system according to a first aspect of the present disclosure includes a text search unit that searches for a text necessary for failure factor analysis of an object from a predetermined database group, and a failure factor generation unit that generates a first failure factor analysis table based on a search result of the text search unit, in which the predetermined database group includes a vector database and a graph database, the vector database is a database including a latent variable obtained by converting text data, and the graph database is a database including, as a graph structure, a correspondence between first character strings each including a word of a general expression, a correspondence between second character strings each including a word of a specific expression, and a correspondence between the first character string and the second character string in text data.

As a result, since the failure factor analysis table can be generated using the two databases of the vector database and the graph database, it is possible to suppress the occurrence of omissions in the failure factor analysis table as compared with the case of using only one of the vector database and the graph database. For example, since it is possible to acquire a proper noun related to the text extracted by the vector database from the graph database, it is possible to suppress the occurrence of omissions in the failure factor analysis table. Therefore, it is possible to support generation of a more accurate failure factor analysis table.

Furthermore, for example, a failure factor analysis support system according to a second aspect is the failure factor analysis support system according to the first aspect, in which the text search unit in the failure factor analysis support system according to the first aspect may calculate at least one of a first similarity indicating a similarity between a text query given as a search input and a text in the graph database and a second similarity indicating a similarity between a latent variable obtained by converting the text query and a latent variable in the vector database, and rank and search a text in the predetermined database group based on at least one of the calculated first similarity and the calculated second similarity.

Consequently, the ranking is performed based on the similarity, so that the text having the higher relationship can effectively be acquired. Therefore, it is possible to effectively support generation of a more accurate failure factor analysis table.

In addition, for example, a failure factor analysis support system according to a third aspect is the failure factor analysis support system according to the second aspect, including a vectorization unit that extracts a latent variable from text data, in which the latent variable extracted by the vectorization unit may be a tensor configured to express a point or spread on a latent variable space, and the text search unit may calculate the first similarity based on at least one of an angle of deviation between tensors and a degree of superimposition of spread between tensors calculated from two tensors, and search for a text necessary for the failure factor analysis using at least the first similarity.

Thus, the graph database can be constructed.

In addition, for example, a failure factor analysis support system according to a fourth aspect is the failure factor analysis support system according to the third aspect, and may include a granularity adjuster that performs processing of aligning granularities of words used in the first failure factor analysis table by using a latent variable obtained from a text of the first failure factor analysis table and a tensor in the latent variable space.

As a result, it is possible to support generation of the failure factor analysis table in which the granularity of each item is more accurate.

In addition, for example, a failure factor analysis support system according to a fifth aspect may be the failure factor analysis support system according to any one of the first to fourth aspects, the failure factor analysis support system including a relation extractor that constructs the graph database, in which the relation extractor may be configured to execute, by using a model that extracts a relationship between units of semantics each including a word or a character string including a word: constructing a general-purpose graph database in which a unit of semantics is constructed only from the first character string and a dedicated graph database including the second character string; and constructing the graph database by extracting a relationship of units of semantics between the general-purpose graph database and the dedicated graph database.

As a result, since the graph database can be constructed, the text in the graph database can be more reliably acquired regardless of the influence of communication or the like.

Furthermore, for example, a failure factor analysis support system according to a sixth aspect is the failure factor analysis support system according to any one of the first to fifth aspects, when a text query given as a search input includes non-text data including at least one of an image, a moving image, a 3D model, and an animated 3D model of a product or a manufacturing device that is the object, the text search unit may search for a necessary text from the predetermined database group using a latent variable obtained by converting at least one of a description text of the non-text data or the non-text data. Furthermore, for example, a failure factor analysis support system according to a seventh aspect is the failure factor analysis support system according to any one of the first to sixth aspects, in which the vector database may include at least one of a latent variable obtained by converting a description text of non-text data including at least one of an image, a moving image, a 3D model, and an animated 3D model, and a latent variable obtained by converting the non-text data.

As a result, even when the non-text data is included in the text query, the text corresponding to the non-text data can be extracted from the database. Therefore, it is possible to generate the failure factor analysis table including the text corresponding to the non-text data. That is, it is possible to effectively support generation of a more accurate failure factor analysis table.

In addition, for example, a failure factor analysis support system according to an eighth aspect is the failure factor analysis support system according to any one of the first to seventh aspects, and may include a display editor that edits a display mode of the first failure factor analysis table based on a difference between a second failure factor analysis table acquired from a user and the first failure factor analysis table.

As a result, the first failure factor analysis table in which the display mode is edited based on the difference can be presented to the user. It is possible to effectively notify the user of the information based on the difference.

In addition, for example, a failure factor analysis support system according to a ninth aspect is the failure factor analysis support system according to the eighth aspect, in which the display editor may edit the display mode so as to highlight a portion indicating the difference in the first failure factor analysis table.

As a result, it is possible to allow the user to easily recognize the portion that is missing in the second failure factor analysis table generated by the user.

Furthermore, for example, a failure factor analysis support system according to a tenth aspect is the failure factor analysis support system according to any one of the first to ninth aspects, in which an agent unit may be configured based on the text search unit and the failure factor generation unit, and the agent unit may input a task definition in which a procedure of failure factor analysis and a goal are organized, information indicating a tool group including at least one of the failure factor generation unit, the text search unit, a Web search engine, and a format corrector, and description of how to use the tool group to one or more large language models, thereby acquiring a processing procedure through planning processing that plans an order a use order of the tool group, and performing failure factor analysis based on the acquired processing procedure.

As a result, the failure factor analysis support system can automatically generate the failure factor analysis table.

In addition, for example, a failure factor analysis support system according to an eleventh aspect is the failure factor analysis support system according to any one of the first to tenth aspects, and may include a database device that stores the predetermined database group.

As a result, the text can be more reliably extracted from the database device.

In addition, for example, a failure factor analysis support system according to a twelfth aspect is the failure factor analysis support system according to any one of the first to eleventh aspects, in which the predetermined database group may be a document database that accumulates technical information regarding the object as text data.

As a result, since a document database including long sentences such as technical information can be used as an information source, it is possible to effectively support generation of a more accurate failure factor analysis table.

Note that the system described in PTL 1 supports the process FMEA by utilizing the maintenance history database including the abnormal code names and failed component names from the past incidents, but it is assumed that the abnormal code name and the failed component name are described by a word or a short sentence. That is, PTL 1 only discloses a technique for supporting the generation of the process FMEA using a short sentence stored in the maintenance history database, and does not disclose or suggest the content related to the failure factor analysis support system according to the twelfth aspect.

In addition, a failure factor analysis support method according to a thirteenth aspect of the present disclosure includes searching for a text necessary for failure factor analysis of an object from a predetermined database group, and generating a failure factor analysis table based on a search result, in which the predetermined database group includes a vector database and a graph database, the vector database is a database including a latent variable obtained by converting text data, and the graph database is a database including, as a graph structure, a correspondence between first character strings each including a word of a general expression, a correspondence between second character strings each including a word of a specific expression, and a correspondence between the first character string and the second character string in text data. In addition, a program according to a fourteenth aspect of the present disclosure is a program for causing a computer to execute the failure factor analysis support method according to the thirteenth aspect.

As a result, the same effects as those of the above failure factor analysis support system can be obtained.

It should be noted that these general or specific aspects may be implemented as a system, a method, an integrated circuit, a computer program, a non-transitory computer-readable storage medium such as a CD-ROM, or any selective combination thereof. The program may be stored in advance in a recording medium, or may be supplied to the recording medium via a wide area communication network including the Internet.

Hereinafter, exemplary embodiments will be specifically described with reference to the drawings.

Note that the exemplary embodiments described hereinafter provide comprehensive or specific examples. Numerical values, shapes, components, disposition positions and connection modes of the components, steps, order of the steps, and the like illustrated in the exemplary embodiments below are merely examples, and are not intended to limit the present disclosure. Furthermore, among the components in the following exemplary embodiment, components not described in the independent claims are explained as optional components.

Furthermore, each of the drawings is a schematic diagram, and is not necessarily strictly illustrated. Thus, scales and the like do not necessarily coincide in the respective drawings, for example. In the drawings, substantially the same components are denoted by the same reference numerals, and redundant description may be omitted or simplified.

In addition, in the present specification, terms indicating relationships between elements, such as same, and terms indicating a shape of an element, such as rectangular shape, numerical values, and numerical ranges are not expressions representing only strict meanings, but are expressions meaning to include a substantially equivalent range, for example, a difference of about several % (alternatively, about 10%).

Ordinal numbers such as “first” and “second” herein do not mean the number or order of components unless otherwise specified, and are used for the purpose of avoiding confusion of components identical in kind and distinguishing the components.

### Exemplary Embodiment

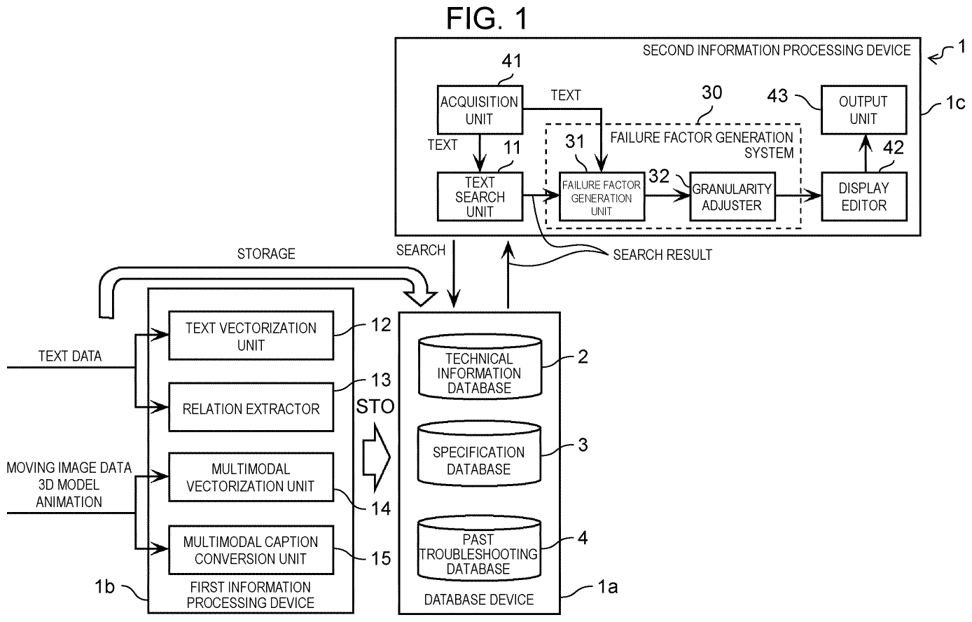

Hereinafter, a failure factor analysis support system according to the present exemplary embodiment will be described with reference to FIGS. 1 to 7.

### 1. Configuration of Failure Factor Analysis Support System

First, a configuration of a failure factor analysis support system according to the present exemplary embodiment will be described with reference to FIG. 1. FIG. 1 is a diagram illustrating a configuration of failure factor analysis support system 1 according to the present exemplary embodiment. FIG. 1 illustrates an exemplary functional configuration of failure factor analysis support system 1, and the functional configuration of failure factor analysis support system 1 is not limited to FIG. 1.

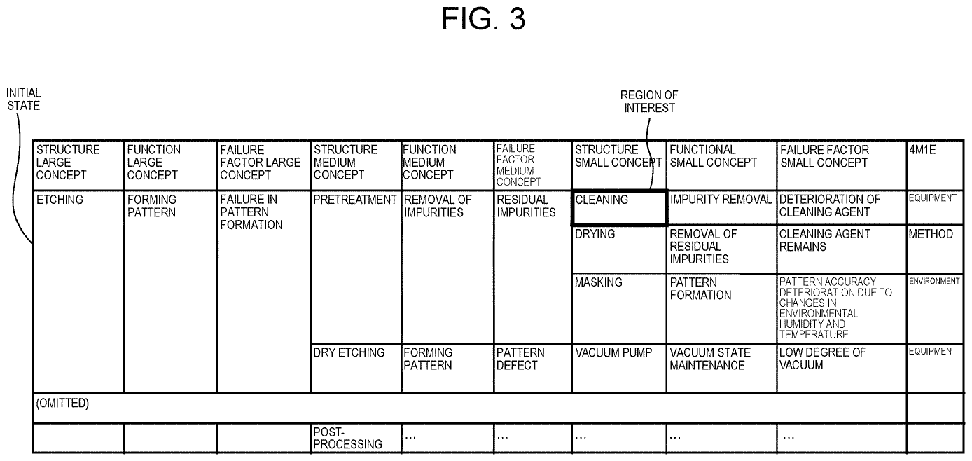

In addition, failure factor analysis support system 1 according to the present exemplary embodiment is an information processing system that supports generation of an FMEA of a product or a production process when a target product is manufactured in a factory or the like. The product is not particularly limited, but may be a home appliance or an industrial product. Note that, in the FMEA, it is important to perform element decomposition of “structure”, “function”, and “failure mode (also referred to as failure factor)” of a product or a production process, and analyze the “structure”, the “function”, and the “failure mode” in association with each other (see FIG. 3 and the like to be described later).

As illustrated in FIG. 1, failure factor analysis support system 1 includes database device 1a, first information processing device 1b, and second information processing device 1c. First information processing device 1b is a device for generating data stored in database device 1a, and second information processing device 1c is a device for executing processing for supporting generation of the failure factor analysis table using the data stored in database device 1a. Database device 1a, first information processing device 1b, and second information processing device 1c may be configured by different devices, or at least two (for example, three) may be realized by an integrated device. In a case where database device 1a, first information processing device 1b, and second information processing device 1c are configured by different devices, communication among database device 1a, first information processing device 1b, and second information processing device 1c may be performed by wireless communication or wired communication.

Database device 1a is a storage device that converts non-text data such as text data, moving image data (moving image), 3D models, and an animated 3D model into text or vector and stores the text or vector. Database device 1a includes technical information database 2 in which technical information such as a technical report, an academic paper, and a patent document is stored as text data, specification database 3 in which past specifications are accumulated, and past trouble database 4 in which past failure factor analysis results are accumulated. The technical report may include, for example, a history of past trouble, a report, an investigation report of a failure case of another company, an internal technical report, a patent document, an academic paper, and the like. In addition, the technical report may include technical information including all failure factors occurring in the past and analysis results thereof. Note that the non-text data may be stored by vectorizing an image together with a moving image or instead of a moving image. Hereinafter, the non-text data will be described as including at least one of an image, a moving image, a 3D model, and an animated 3D model.

A database group is formed by a set of technical information database 2, specification database 3, and past trouble database 4. It can be said that the database group includes a document database in which technical information is accumulated as text data.

Here, the text data may include relatively long sentences such as specifications and technical information. The relatively long sentence may be, for example, a sentence including a subject and a verb, or a sentence including a predetermined number of characters or more. The predetermined number of characters may be, for example, 10, 20, 50, 100, or 1000. For example, a relatively long sentence may be a report of about several thousand characters. In addition, the report may include an image, a table, a figure, an illustration, and the like.

In technical information database 2, text data and an output (for example, latent variables to be described later, and the like) of first information processing device 1b are stored in association with each other.

The database group includes at least one of the vector database and the graph database, and includes both the vector database and the graph database in the present exemplary embodiment. The database group is an example of a predetermined database. The vector database is a database including a latent variable obtained by converting text data, and is, for example, a database including at least the entire technical information or a text obtained by dividing the entire technical information and a latent variable obtained by vectoring the text by text vectorization unit 12.

Furthermore, the vector database may include at least one of a latent variable obtained by converting the description text of the non-text data including at least one of an image, a moving image, a 3D model, and an animated 3D model, and a latent variable obtained by converting the non-text data. For example, the vector database may be a database in which a latent variable obtained by vectorizing non-text data is at least one of a key and a value. Such a latent variable is generated by multimodal vectorization unit 14.

The graph database is a database that stores the relation between the units of semantics extracted from the technical information by relation extractor 13 as a graph structure. The unit of semantics is a unit representing one meaning in the character string. The relation is expressed by a node constituted by a unit of semantics centered on a noun and an edge constituted by a verb or a verb phrase describing a relationship between units of semantics. Since the node and the edge can have an attribute, the attached information or the value of the node and the edge may be given to the latent variable extracted by text search unit 11 as an attribute. Such latent variables are utilized when text search unit 11 searches. Note that examples of the attached information include, but are not limited to, images included in sentences, moving images of related products or processes, caption text generated from at least one of a 3D CAD model and an animated 3D CAD model, latent variables vectorized by multimodal vectorization unit 14, and the like. Furthermore, a text generated by multimodal caption conversion unit 15 may be used as the caption text.

Database device 1a includes a nonvolatile storage device (Solid State Drive (SSD) or Hard Disk Drive (HDD)) or the like.

First information processing device 1b generates information included in technical information database 2 of database device 1a. First information processing device 1b includes text vectorization unit 12, relation extractor 13, multimodal vectorization unit 14, and multimodal caption conversion unit 15. Functions of text vectorization unit 12, relation extractor 13, multimodal vectorization unit 14, and multimodal caption conversion unit 15 are implemented, for example, by a processor such as a central processing unit (CPU) included in first information processing device 1b executing a program stored in a memory included in first information processing device 1b.

Text vectorization unit 12 is an example of a vectorization unit, and converts the input text into a latent variable using a model that outputs a latent variable corresponding to the text with the text as an input. That is, text vectorization unit 12 is a processing unit for constructing a vector database. Outputting the latent variable corresponds to extracting the latent variable.

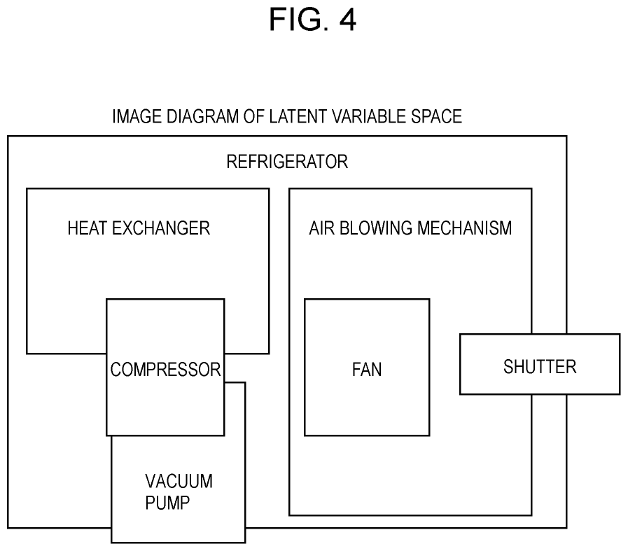

The latent variable is a tensor representing a point or spread in the other dimensional space, and is, for example, a tensor configured to represent the point or the spread on the latent variable space. Tensors are used for vector search. The model may be a machine learning model, for example, an encoding/decoder type model. As an exemplary embodiment of the model, there are exemplified Text2Vec and Text2Box, and a language model in which a text generation task is learned. Text2Vec is a model that converts text into a vector. Furthermore, Text2Box is a model that expresses text in a box (see FIG. 4 to be described later), and is, for example, a model that expresses text in a box by learning a latent variable by Box Embedding. By representing by a box, it is possible to know a relationship between data such as an intersection and an inclusion relationship. By learning the latent variable by Box Embedding, it is possible to learn the model so that the latent variable has a volume as compared with general Text2Vec. In addition, by utilizing Box Embedding, it is possible to determine whether the granularity of the term of the failure factor analysis result is correct and adjust the granularity. The granularity of the term is set by the relationship or similarity between the terms. For example, the same or similar granularity is set when the relationship between terms is high or the similarity is high.

Relation extractor 13 is a processing unit that constructs a general-purpose graph database in which units of semantics are constructed only from common nouns and a dedicated graph database including proper nouns using a model that extracts a relationship between units of semantics including words or word strings, and constructs a graph database by extracting a relationship between units of semantics of the general-purpose graph database and the dedicated graph database. Extracting the relationship means associating a word or a word string having a relationship with a word or a word string included in the general-purpose graph database and a word or a word string included in the dedicated graph database. As a result, when the word or word string included in the general-purpose graph database is searched, the word or word string included in the dedicated graph database associated with the word or word string can also be extracted.

Relation extractor 13 generates a graph database including, as a graph structure, a correspondence between first character strings each including a word of a general expression, a correspondence between second character strings each including a word of a specific expression, and a correspondence between the first character string and the second character string included in a text with the text as an input. The general expression is an expression used on a daily basis, and the specific expression is an expression (for example, expressions used by experts) used uniquely, such as a product name, internal materials, or a product specification sheet. For example, when the general expression is a laser (laser device), the specific expression is a model number of the laser, a failure history of the laser, a specification sheet of the laser, or the like. Furthermore, the word is, for example, the smallest language unit having meaning. The word includes, for example, at least one of a noun, an adjective, an adjective verb, an adverb, a suffix, and the like. The character string includes at least one of one or more words (for example, two or more words), a conjunctive word, a noun clause, and the like.

The correspondence between the first character string and the second character string may be a correspondence between words, a correspondence between words and character strings, or a correspondence between character strings.

Hereinafter, an example in which relation extractor 13 distinguishes between a common noun that is an example of a first character string including a word of the general expression and a proper noun that is an example of a second character string including a word of the specific expression will be described. For example, it can be said that relation extractor 13 distinguishes between a common noun and a proper noun included in a text using the text as an input, and then describes, in a graph structure, a correspondence among the common nouns, a correspondence between the proper nouns, and a correspondence between the common noun and the proper noun.

It can also be said that relation extractor 13 acquires a correspondence between a knowledge graph of a common noun and a knowledge graph in an element specific to the manufacturing industry using Box Embedding. Common nouns are included in the general-purpose graph database, and proper nouns are included in the dedicated graph database. The dedicated graph database (for example, knowledge graphs in manufacturing industry specific factors) may include a factory internal document and a product specification sheet together with a proper noun or in place of a proper noun, or may include information related to 5M1E (or 4M1E) in the manufacturing industry.

As a result, since the correspondence between the common nouns and the proper nouns is known in both the search by the common nouns and the search by the proper nouns, the structure, function, and failure mode of the product or process can be searched without omission. For example, in a case where “cleaning” is included in the general-purpose graph database, a history of defects that have occurred in the cleaning process is included in the dedicated graph database as the internal material, it is extracted that they are related to each other, and second information processing device 1c can detect that there is an omission in the defect that can occur in the cleaning from the term of cleaning in the FMEA table being generated by the user.

Multimodal vectorization unit 14 uses data based on non-text data including at least one of an image, a moving image, a 3D model, and an animated 3D model of a product or a manufacturing device as an input, and converts the input data into a latent variable using a model that outputs a latent variable corresponding to the data. The data based on the non-text data may be the non-text data itself or the description text data describing the non-text data.

Note that the description text data may be converted into a latent variable by text vectorization unit 12.

Multimodal caption conversion unit 15 converts the input non-text data into a caption text using a model that receives at least one of an image included in a sentence, a moving image of a related product or process, a 3D CAD model, and an animated 3D CAD model as an input and outputs caption text.

Note that the information input to the model of the multimodal caption conversion unit 15 only needs to include at least non-text data, and may include text data, for example.

Second information processing device 1c executes information processing for inputting a text query and outputting a failure factor analysis result corresponding to the text query. Second information processing device 1c includes acquisition unit 41, text search unit 11, failure factor generation system 30, display editor 42, and output unit 43. An agent unit is formed including at least text search unit 11 and failure factor generation system 30. Functions of acquisition unit 41, text search unit 11, failure factor generation system 30, and display editor 42 are implemented, for example, by a processor such as a CPU included in second information processing device 1c executing a program stored in a memory included in second information processing device 1c.

Acquisition unit 41 receives a user's input. Acquisition unit 41 may receive a user's input to a button, a keyboard, a touch panel, or the like, may receive a user's voice as an input by a microphone or the like, or may receive an input from a user via communication by a communication circuit or the like. Acquisition unit 41 receives a text query given as a search input.

Text search unit 11 searches for text necessary for failure factor analysis of a product or a production process (an example of an object) from data stored in database device 1a.

Note that the failure factor search system may be formed including at least text search unit 11. The object may be a manufacturing device included in the production process.

Failure factor generation system 30 generates and outputs a failure factor analysis result from the text acquired via acquisition unit 41. Failure factor generation system 30 includes failure factor generation unit 31 and granularity adjuster 32.

Failure factor generation unit 31 generates a failure factor analysis result (for example, the second failure factor analysis table) from at least one text of the specification or the first failure factor analysis table that is being generated by the user. Failure factor generation unit 31 generates a failure factor analysis result based on the search result of text search unit 11. It can also be said that failure factor generation unit 31 updates the first failure factor analysis table to the second failure factor analysis table based on the search result of text search unit 11.

Granularity adjuster 32 performs processing of aligning the granularity of the word using the latent variable obtained by text vectorization unit 12 from the text of the failure factor analysis result generated by failure factor generation unit 31 and the tensor on the latent variable space. The word here may be a word indicating a structure constituting a product.

For example, in a case where the latent variable extracted by text vectorization unit 12 is a tensor configured to express the spread, it is possible to calculate the similarity between two tensors (that is, two pieces of text data) based on the degree of superimposition of the spreads of the tensors. The hierarchical relationship can be calculated by applying the clustering processing based on the value itself representing the hierarchical relationship of the spread or the feature amount such as the superimposition relationship or the moment. For the calculation of the similarity, a Dice coefficient, a Jaccard coefficient, KL-Divergence, JS-Divergence, a Hausdorff distance, an N-order moment, and the like are used, but the calculation is not limited thereto. In addition, the two tensors include a tensor that is a latent variable stored in database device 1a and a tensor that is a latent variable generated from the text query.

Note that the functions of failure factor generation unit 31 and text search unit 11 may be realized by Retrieval-Augmented Generation (RAG) using artificial intelligence (AI) in which a search function is combined with a large language model (LLM), or a Reasoning (ReAct) and Action (LLM Agent).

Granularity adjuster 32 can further align the granularity of the term by performing combination optimization processing such that the number of times of performing the exchange processing with the term extracted from the database group is minimized such that the similarity of the latent variable in the failure factor analysis result is minimized and the number of times of exchanging the term is minimized.

In FTA (Fault Tree Analysis) or FMEA, it is considered important to hierarchize and organize structures, functions, and failure modes as a superordinate concept and a subordinate concept, respectively. Optimizing the granularity of terms in this hierarchy is important in reducing omission of failure factor analysis results.

Note that failure factor generation system 30 may include at least failure factor generation unit 31.

Display editor 42 edits the failure factor analysis result output from failure factor generation system 30. For example, when there is an excess or deficiency in the failure factor analysis result (first failure factor analysis table) generated by the user, display editor 42 may perform editing to highlight the excess or deficiency portion. The highlight display may be, for example, a display mode of changing a display color, blinking, or the like different from other portions.

Output unit 43 outputs the failure factor analysis result. Output unit 43 may include a display such as a liquid crystal display device and display the failure factor analysis result. In addition, output unit 43 may include a communication circuit (or a communication module) and transmit information indicating a failure factor analysis result to an external display device.

Acquisition unit 41, display editor 42, and output unit 43 constitute a display editing system. Note that display editor 42 may not be provided.

### 2. Operation of Failure Factor Analysis Support System

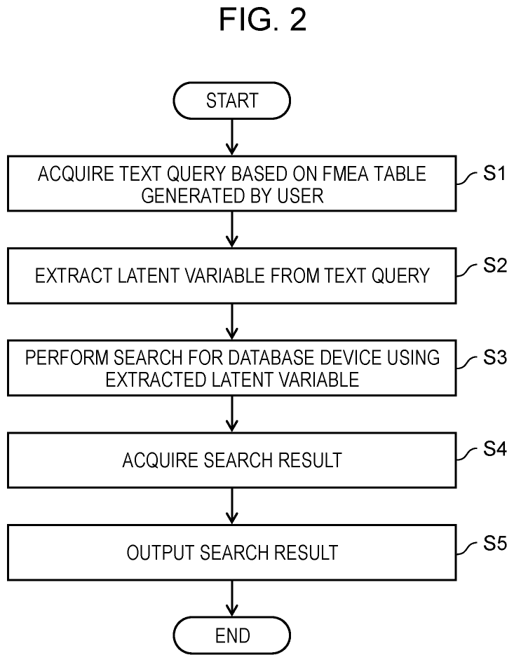

Next, an operation of failure factor analysis support system 1 configured as described above will be described with reference to FIGS. 2 to 7. FIG. 2 is a flowchart illustrating a first operation (failure factor analysis support method) of failure factor analysis support system 1 according to the present exemplary embodiment. The first operation includes a search operation on database device 1a by text search unit 11. FIG. 3 is a diagram illustrating an FMEA table (an example of a second failure factor analysis table) that is being generated by the user.

As illustrated in FIG. 2, acquisition unit 41 acquires a text query based on the FMEA table generated by the user (S1). The text query may include non-textual data including at least one of an image, a moving image, a 3D model, and an animated 3D model of the product or manufacturing device. The text query is also referred to as a search query.

As illustrated in FIG. 3, the FMEA table includes elements of “structure”, “function”, and “failure factor” of a product or a production process. The structure indicates a content of work in each production process, the function indicates what the production process forms, and the failure factor indicates a content of a defect that may occur when the function is incomplete. Furthermore, in the FMEA table, each element is hierarchized (in the example of FIG. 3, a large concept, a medium concept, and a small concept are illustrated). More detailed information is indicated in the order of the large concept, the medium concept, and the small concept. It can be said that each of the large concept, the medium concept, and the small concept corresponds to the granularity.

FIG. 3 illustrates an example in which the large concept of the structure is etching, the medium concept is pretreatment (one treatment performed in an etching step), and the small concept is cleaning, drying, and masking (fine treatment included in the pretreatment). The text query includes confirming that the cleaning is the region of interest, that is, whether there is no excess or deficiency in the information of the cleaning.

Furthermore, the text query may include an index serving as a goal when searching database device 1a. For example, the upper limit number of the number of items included in the small concept of the configuration may be set as the goal. Here, it is assumed that the goal is set to five. When the goal is achieved, the search processing ends. In a case where a goal is set, the information of the goal is also included in the text query.

With reference to FIG. 2 again, next, second information processing device 1c extracts latent variables from the text query given as the search input (S2). Second information processing device 1c divides the text query into chunks, and extracts the latent variable for each of the divided chunks. For example, in a case where text search unit 11 has a function similar to that of text vectorization unit 12, the processing in step S2 may be executed by text search unit 11 or may be executed by text vectorization unit 12.

Next, text search unit 11 executes a search on database device 1a using the extracted latent variable (S3). For example, text search unit 11 calculates at least one of a first similarity indicating the similarity between the text query given via acquisition unit 41 and the text in the graph database and a second similarity indicating the similarity between the latent variable obtained by inputting the text query to text vectorization unit 12 and the latent variable in the vector database, and searches for the text in a predetermined database group by ranking the texts according to the calculated similarity.

The first similarity and the second similarity may be acquired using LLM. The first similarity may be obtained by inputting two texts and a text query including calculating the similarity to the LLM. In addition, the first similarity (that is, the similarity between the texts) may be calculated using N-gram similarity, tf-idf, BM25, B42, a Jaro-Winkler distance, a Levenshtein distance, a Damerau-Levenshtein distance, or the like.

Furthermore, the second similarity may be calculated by a degree of superimposition (for example, the degree of volume superimposition in the latent variable space) between the spread of the latent variable of the text query in the latent variable space and the spread of the latent variable of the text data stored in database device 1a. The higher the degree of superimposition, the higher the degree of similarity. Furthermore, the second similarity may be calculated by an angle of deviation (for example, an angle formed by two vectors) between the latent variable of the text query in the latent variable space and the latent variable of the text data stored in database device 1a. The smaller the angle of deviation, the higher the similarity.

Note that examples of similarity calculation between vectors include cosine similarity, ScaNN, KL-divergence, JS-divergence, and the like, but are not limited thereto.

FIG. 4 is an image diagram of a latent variable space according to the present exemplary embodiment. For convenience, FIG. 4 illustrates an image diagram of a latent variable space in the refrigerator. This is generated from the latent variable stored in database device 1a.

A rectangular frame illustrated in FIG. 4 indicates the spread of the latent variable. Specifically, it indicates the spread of each of the refrigerator, the heat exchanger, the compressor, the vacuum pump, the air blowing mechanism, the fan, and the shutter in the latent variable space. Since the heat exchanger and the compressor operate in association with each other, a part of the frame overlaps. Since the fan is included in the air blowing mechanism, the frame of the fan is located in the frame of the air blowing mechanism. Note that the latent variable space may be a space of two or more dimensions.

When the latent variable of the text query is arranged in the latent variable space illustrated in FIG. 4, text search unit 11 determines with which element the degree of superimposition is large (for example, most). That is, text search unit 11 extracts the latent variable closest to the latent variable of the text query among the plurality of latent variables stored in database device 1a. It can also be said that text search unit 11 specifies which component among the components of the manufacturing device the latent variable of the text query indicates.

For example, in a case where the latent variable of the text query has the largest degree of superimposition with the latent variable of the compressor, text search unit 11 specifies that the latent variable of the text query corresponds to the compressor. Based on FIG. 4, text search unit 11 can recognize that the compressor is related to the heat exchanger and the vacuum pump and is not related to the air blowing mechanism.

In the example of FIG. 3, for example, a latent variable space including a latent variable of etching is used.

Note that, in a case where a text query including non-text data, the non-text data including at least one of an image of a product or a manufacturing device, a moving image, a 3D model, and an animated 3D model, is input to the text query in step S1, text search unit 11 may convert at least one of the description text of the non-text data or the non-text data into a latent variable in step S2, and, in step S3, search for a necessary text from a predetermined database group using the latent variable converted. The description text is character information for describing non-text data, and for example, may include text information included in a query including non-text data, or may include text information obtained by searching text or non-text data using a Web engine or the like.

Referring to FIG. 2 again, text search unit 11 acquires a search result including information (for example, words or word strings) obtained by converting the extracted latent variable into text (decoding) (S4). The search result is a set of one or more words.

For example, text search unit 11 extracts the text so as to achieve the number of differences between the upper limit number of items set in the FMEA table and the number of items in the corresponding portion of the FMEA table generated by the user. For example, in a case where the upper limit number of items of cleaning in the small concept of the structure is set to 3, and the number of corresponding items of cleaning in the FMEA table generated by the user is 1, text search unit 11 may extract, for example, two texts related to cleaning from the one with higher similarity.

Note that, in a case where the upper limit number is not set, the processing of extracting the text is not executed, and all the texts may be acquired. Furthermore, the upper limit number is an example of the goal.

Next, text search unit 11 outputs the search result to failure factor generation unit 31 (S5).

In a case where information regarding a defect in cleaning that is a region of interest is included in the search result, failure factor generation unit 31 adds the information to the FMEA table acquired from the user.

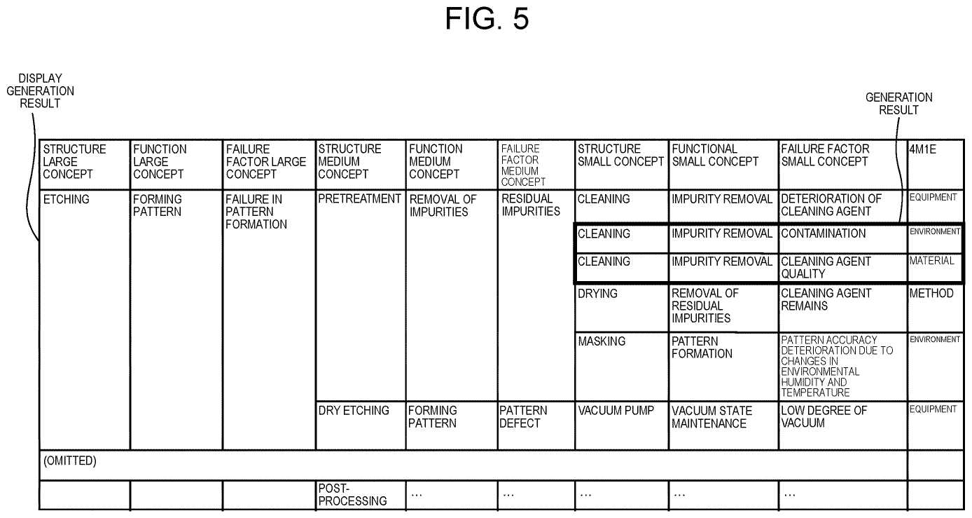

FIG. 5 is a diagram illustrating a display example reflecting a search result according to the present exemplary embodiment. FIG. 5 illustrates an FMEA table (that is, the updated FMEA table) obtained by adding a search result to the FMEA table illustrated in FIG. 3 by failure factor generation unit 31.

As illustrated in FIG. 5, failure factor generation unit 31 adds a generation result in which the small concept of the failure factor includes “contamination” and “cleaning agent quality” to the FMEA table illustrated in FIG. 3 as the information regarding the defect in the cleaning which is the region of interest. This generation result is considered to be information that should originally be included in the FMEA table, but has not been described due to omission of extraction by the user. That is, according to second information processing device 1c, the missing part of the FMEA table generated by the user can be filled using the information of database device 1a.

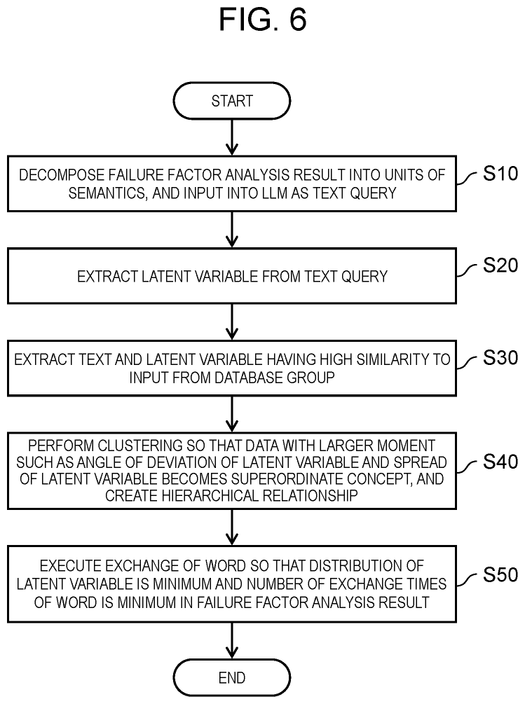

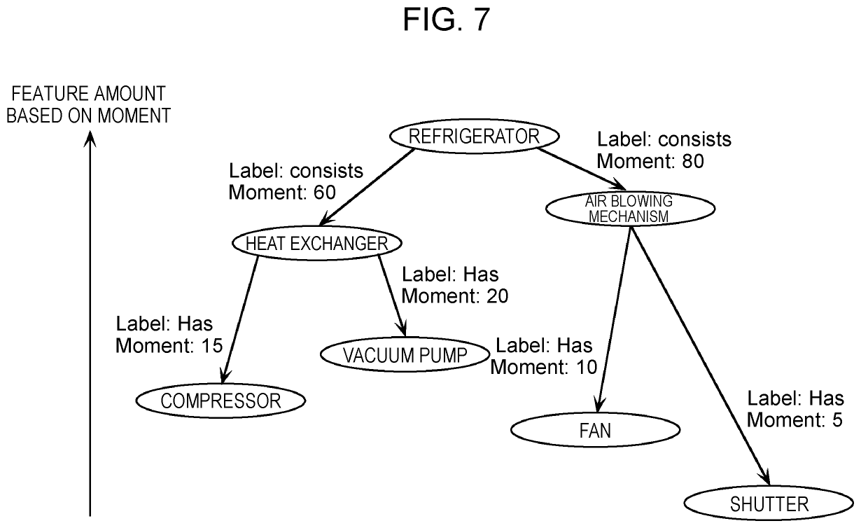

Next, the granularity adjustment processing for adjusting the granularity of the word included in the FMEA table will be described with reference to FIGS. 6 and 7. FIG. 6 is a flowchart illustrating a second operation (failure factor analysis support) of failure factor analysis support system 1 according to the present exemplary embodiment.

As illustrated in FIG. 6, granularity adjuster 32 decomposes the failure factor analysis result into units of semantics, and inputs the units of semantics to the LLM as a text query (S10).

Next, granularity adjuster 32 extracts a latent variable from the text query (S20). Granularity adjuster 32 divides the text query into chunks, and extracts the latent variable for each divided chunk. For example, in a case where granularity adjuster 32 has a function similar to that of text vectorization unit 12, the processing of step S20 may be executed by granularity adjuster 32 or may be executed by text vectorization unit 12.

Next, granularity adjuster 32 extracts a text and a latent variable having high similarity with the input (here, a text query) from the database group (S30). Granularity adjuster 32 extracts a latent variable having a high degree of similarity (for example, it is the highest or higher than or equal to a predetermined value) to the latent variable of the text query, and extracts a text associated with the extracted latent variable.

Next, granularity adjuster 32 performs clustering so that data having a larger moment such as the angle of deviation of the latent variable and the spread of the latent variable become superordinate concepts, and creates a hierarchical relationship (S40).

FIG. 7 is a diagram for explaining the granularity according to the present exemplary embodiment. FIG. 7 is a diagram for explaining the granularity in the refrigerator illustrated in FIG. 4. The vertical axis represents the feature amount based on the moment. Furthermore, the numerical value in the drawing is a value based on the moment, and may be, for example, Box Embedding itself or a value indicating the volume size of the rectangular frame.

Components having similar feature amounts illustrated in FIG. 7 are determined to have the same granularity. For example, ranges of feature amounts having the same granularity may be set. For example, it is assumed that a feature amount of 60 or more constitutes one granularity, and a feature amount less than 60 constitutes one granularity. That is, it is assumed that the components of the refrigerator are divided into three levels including the refrigerator (there are three granularities). For example, the fact that the compressor and the vacuum pump come next to the heat exchanger can be evaluated by the volume size illustrated in FIG. 4.

For example, in a case where the input is “compressor”, “vacuum pump”, or “air blowing mechanism”, it can be seen that “air blowing mechanism” corresponds to a superordinate concept, and thus, “fan” and “shutter” of a subordinate concept have closer moments and can be said to be words with closer granularity.

Referring to FIG. 6 again, next, granularity adjuster 32 executes the word exchange so that the dispersion of the latent variable is minimized in the failure factor analysis result and the number of times of exchange with the word on the database group or the word (that is, the word included in the FMEA table generated by failure factor generation unit 31) generated by LLM is minimized (S50). For example, the processing in step S50 is executed using at least one (three in the following description) of the overall optimum, the local optimum, and the maintenance of the current state.

In the overall optimum, whether consistency is obtained with respect to the entire FMEA table is used for evaluating whether the word is in an optimal state, and the evaluation value is used for exchanging the word. Granularity adjuster 32 may evaluate the perfection of the entire FMEA table using LLM and evaluate the overall consistency in a plurality of stages (for example, 10 stages), or may acquire the evaluation value as an output of a regression model by inputting a text to the regression model learned using a data set constructed by a pair of the text and the evaluation value (for example, 10 stages). In addition, granularity adjuster 32 converts the acquired evaluation value (for example, 10 stages) into a range of 0 to 1. Let the converted value be L_overall optimum(x).

In the local optimum, the variance of the latent variable is calculated in the failure factor analysis result, and the variance is used for the word exchange. As a result, the granularity can be adjusted so that the dispersion of the latent variable is minimized. The minimum dispersion of the latent variable means minimization (for example, the frames in the latent variable space illustrated in FIG. 4 more coincide with each other) of Box Embedding with respect to two texts. Let the variance be L_local optimum(x).

In the current maintenance, the number of times of exchange with the word on the database group or the word generated by LLM is used for the exchange of the word. As a result, the granularity can be adjusted so that the number of times of exchange is minimized. When the number of times of exchange is N, granularity adjuster 32 sets the logarithm of the number of times of exchange N to L_current maintenance(x). For example, log 2(N) is exemplified as the current maintenance(x).

Granularity adjuster 32 calculates three indexes and executes the granularity adjustment so as to minimize the calculation result. The calculation may be, for example, addition or weighted addition. For example, the following Expression 1 may be used as the objective function y(x) of optimization.

y(x)=L_overall optimum(x)+w_1×L_local optimum(x)+w_2×L_current maintenance(x) (Expression 1)

In Expression 1, w_1 and w_2 are weights, and can take a value of 0 or more and 1 or less, for example. The weights w_1 and w_2 may be set in advance. Granularity adjuster 32 may determine that the granularity is incorrect when the value of the objective function y(x) is greater than or equal to the threshold value.

In a case where the granularity in the failure factor analysis result is determined to be incorrect, granularity adjuster 32 may execute, for example, word exchange. It can also be said that granularity adjuster 32 replaces the items of the failure factor analysis result such that the items of the same granularity are arranged in the same concept (large concept, medium concept, small concept) in the failure factor analysis result. For example, in a case where the “post-processing” of the structural medium concept is arranged in the small concept of the structure, the granularity adjuster 32 moves the item of the “post-processing” from the small concept of the structure to the medium concept column based on the graph indicating the components of the product corresponding to FIG. 7.

As a result, the granularity adjustment of each element of the failure factor analysis result is realized.

### Modification of Exemplary Embodiment

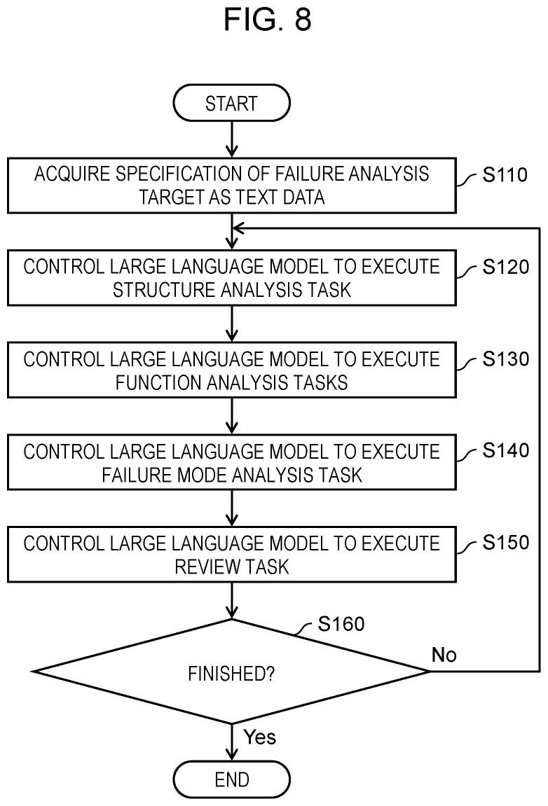

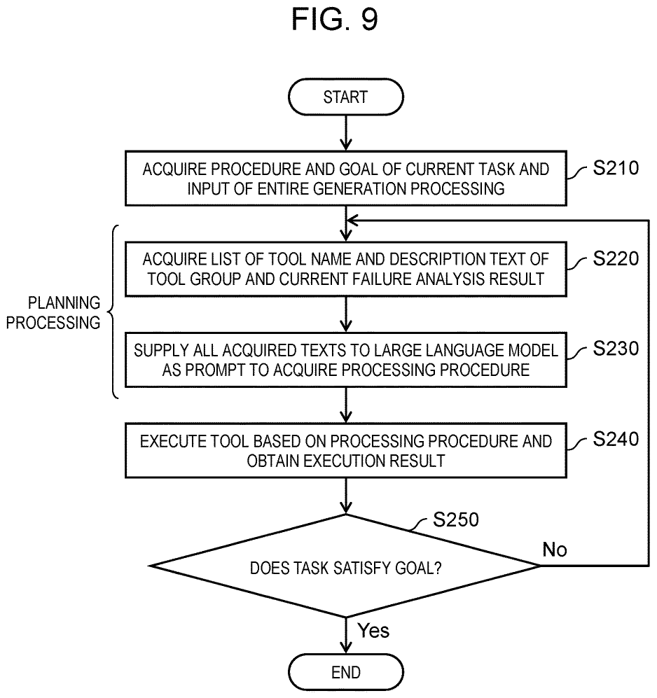

Hereinafter, a failure factor analysis support system according to the present modification will be described with reference to FIGS. 8 and 9. Hereinafter, differences from the exemplary embodiment will be mainly described, and the description of the contents same as or similar to those of the exemplary embodiment will be omitted or simplified. In the present modification, a case where the failure factor analysis support system automatically generates the FMEA table will be described. Note that the configuration of the failure factor analysis support system according to the present modification may be the same as that of failure factor analysis support system 1 according to the exemplary embodiment, and the description will be given below using reference numerals of failure factor analysis support system 1 according to the exemplary embodiment.

FIG. 8 is a flowchart illustrating an operation (failure factor analysis support method) of automatically generating the FMEA table according to the present modification.

As illustrated in FIG. 8, second information processing device 1c acquires the specification of the failure analysis target as text data (S110).

Next, second information processing device 1c performs control to cause the large language model to perform the structure analysis task (S120), performs control to cause the large language model to perform the function analysis task (S130), and performs control to cause the large language model to perform the failure mode analysis task (S140). The processing of steps S120, S130, and S140 will be described later with reference to FIG. 9. Note that the processing in steps S120, S130, and S140 is performed using database device 1a.

The structure analysis task is a task of generating information related to a structure in the FMEA table. The structure analysis task is, for example, a task of generating a large concept, a medium concept, and a small concept regarding a structure. For example, information of the large concept, the medium concept, and the small concept regarding the structure may be acquired by generating the large concept, the medium concept, and the small concept regarding the structure, and by inputting a text query including a specification of a manufacturing device, and the like to the LLM.

The function analysis task is a task of generating information related to a function in the FMEA table. The function analysis task is, for example, a task of generating a large concept, a medium concept, and a small concept regarding a function. For example, information of the large concept, the medium concept, and the small concept regarding the function may be acquired by generating the large concept, the medium concept, and the small concept regarding the function, and by inputting a text query including a specification of a manufacturing device, and the like to the LLM.

The failure mode analysis task is a task of generating information regarding a failure mode in the FMEA table. The failure mode analysis task is, for example, a task of generating a large concept, a medium concept, and a small concept regarding a failure mode. For example, information of the large concept, the medium concept, and the small concept regarding the failure mode may be acquired by generating the large concept, the medium concept, and the small concept regarding the failure mode, and by inputting a text query including a specification of a manufacturing device, and the like to the LLM.

Note that the processing order of steps S120, S130, and S140 is not limited, and may be interchanged or may be executed in parallel. In addition, the structure analysis task, the function analysis task, and the failure mode analysis task are also collectively referred to as an analysis task.

Next, second information processing device 1c controls the large language model to perform a review task (S150). The review task is a task of determining whether it is necessary to review the text generated by the processing in steps S120 to S140.

Next, second information processing device 1c determines whether the processing for all the tasks has been completed (S160). For example, in a case where it is determined that the processing for all the tasks has ended (Yes in S160), second information processing device 1c ends the processing, and in a case where it is determined that the processing for all the tasks has not ended (No in S160), second information processing device 1c proceeds to the next task and executes the processing in and after step S120. The determination that all the tasks are ended means that the FMEA table satisfying the task definition is automatically generated.

In the case of No in step S160, the process returns to step S120 and the processing is continued. That is, the FMEA table is generated by repeatedly executing the analysis task and the review task.

FIG. 9 is a flowchart illustrating an operation (failure factor analysis support method) of each task according to the present modification. For example, the processing is executed for each task of the analysis task. Steps S220 and S230 are an example of the planning processing of causing the large language model to consider a procedure of creating the FMEA table.

As illustrated in FIG. 9, second information processing device 1c acquires the procedure and goal of the current task and the input of the entire generation processing (S210). The current task is a structure analysis task when the processing in step S120 is executed.

The procedure indicates the order of use of a plurality of tools (tool group) used when the current task is executed. The goal is the number of items in the FMEA table, and is, for example, the number of items of the small concept. The goal may be set for one large concept, or may be set for the entire FMEA table. The task definition including the procedure and the goal is generated in advance and stored in a storage (for example, database device 1a). Furthermore, the task definition may include a processing procedure for determining whether the granularity of the word is appropriate.

The tool group includes at least one of failure factor generation system 30 (for example, failure factor generation unit 31), a failure factor search system (for example, text search unit 11), a Web search engine, and a format corrector. The Web search engine is a search engine that searches a Web page, and is a system that provides highly relevant information to a search target keyword. In a case where the format of the FMEA table is changed after the FMEA table is generated, the format corrector executes processing of correcting the format.

Next, second information processing device 1c acquires the list of tool names of the tool group, the description text, and the current failure factor analysis result (S220). The list of tool names of the tool group is a list of identification information for identifying a tool used when the task is executed. The tools included in the tool group may be different depending on the task to be executed, or may be common to the tasks.

The description text is a text including a description of how to use each tool, and includes a definition of each tool. The definition of the tool includes information indicating a situation in which each tool is used. For example, a Web search engine may be defined to be used for a word that cannot be understood with general knowledge. Furthermore, for example, in the case of a format corrector, it may be defined that the format corrector is used in a case where the format of the FMEA table is broken. The current failure factor analysis result is a failure factor analysis result generated at the time of executing step S220.

Next, second information processing device 1c gives the entire acquired text as a prompt to the large language model, and acquires a processing procedure as an output of the large language model (S230). The processing procedure here includes a processing procedure in a case where a word that is not learned in the LLM is input. As a processing procedure, second information processing device 1c determines which tool among failure factor generation system 30, the failure factor search system, the Web search engine, and the format corrector is used when a word that the LLM has not learned is input (for example, in which order to use each tool).

Next, second information processing device 1c executes processing using the tool based on the processing procedure, and acquires the execution result. For example, second information processing device 1c may acquire the execution result using a search engine of the browser.

Next, second information processing device 1c determines whether the task satisfies the goal (S250). For example, second information processing device 1c determines whether texts equal to or less than the upper limit number (goal) of the items of cleaning have been extracted.

In a case where it is determined that the task satisfies the goal (Yes in S250), second information processing device 1c ends the processing. In a case where it is determined that the task does not satisfy the goal (No in S250), second information processing device 1c ends the processing.

### Other Exemplary Embodiments

Although the failure factor analysis support system and the like according to one or more aspects have been described above based on the exemplary embodiment and the like, the present disclosure is not limited to the exemplary embodiment and the like. Configurations in which various variations conceived by those skilled in the art are applied to the present exemplary embodiments, and configurations established by combining components in different exemplary embodiments may also fall within the present disclosure, without departing from the gist of the present disclosure.

For example, in the above-described exemplary embodiment and the like, an example in which the second information processing device generates the FMEA table has been described, but the present disclosure is not limited thereto. For example, the second information processing device may be configured to output a table based on Design Review Based on Failure Mode (DRBFM)/HAZOP (HAZard and OPerability studies)/Fault Tree Analysis (FTA).

In addition, in the above-described exemplary embodiments and the like, each component may be configured by dedicated hardware or may be implemented by executing a software program suitable for each component. Each component may be achieved by causing a program executer, such as a CPU or a processor, to read and execute the software program stored in a recording medium, such as a hard disk or a semiconductor memory.

In addition, the order in which the steps in each flowchart are executed is for specifically describing the present disclosure, and may be an order other than the above. In addition, some of the steps may be executed simultaneously (in parallel) with other steps, or some of the steps need not be executed.

In addition, the division of the functional blocks in the block diagram is an example, and a plurality of functional blocks may be implemented as one functional block, one functional block may be divided into a plurality of functional blocks, or some functions may be transferred to another functional block. In addition, functions of a plurality of functional blocks having similar functions may be processed in parallel or in a time division manner by single hardware or software.

In addition, the failure factor analysis support system according to the above exemplary embodiment and the like may be achieved as a single device or may be achieved by a plurality of devices. When the failure factor analysis support system is achieved by a plurality of devices, each component included in the failure factor analysis support system may be distributed to the plurality of devices in any manner. For example, the present disclosure may be achieved by cloud computing or edge computing. When the failure factor analysis support system is achieved by a plurality of devices, a communication method used between the plurality of devices is not particularly limited, and may be wireless communication or wired communication. In addition, wireless communication and wired communication may be combined between the devices.

In addition, each component described in the above exemplary embodiment and the like may be achieved as software, or may be typically achieved as a large-scale integration (LSI) circuit that is an integrated circuit. The constituent elements may each be integrated into one chip, or some or all of the constituent elements may be integrated into one chip. The LSI referred to herein may also be called IC, system LSI, super LSI, or ultra LSI depending on a degree of integration. The circuit integration method is not limited to LSI, and may be implemented by a dedicated circuit (a general-purpose circuit that executes a dedicated program) or a general-purpose processor. A field-programmable gate array (FPGA) that can be programmed after manufacture of the LSI circuit or a reconfigurable processor in which connections and settings of circuit cells disposed inside the LSI circuit can be reconfigured may be used. Furthermore, if a circuit integration technology replacing LSI appears due to progress of semiconductor technologies or other derived technologies, the components may be integrated using the technology.

A system LSI is a super multifunctional LSI manufactured by integrating a plurality of processing units on one chip, and is specifically a computer system including a microprocessor, a read-only memory (ROM), a random-access memory (RAM), and the like. The ROM stores a computer program. The microprocessor operates according to the computer program to allow the system LSI to achieve its functions.

One aspect of the present disclosure may be a computer program that causes a computer to execute characteristic steps included in the failure factor analysis supporting method illustrated in any one of FIGS. 2, 6, 8, and 9.

Furthermore, for example, the program may be a program to be executed by a computer. Furthermore, another aspect of the present disclosure may be a non-transitory computer-readable recording medium storing such a program. For example, such a program may be stored in a recording medium and distributed or circulated. For example, the distributed program is installed in another device including a processor, and the program is executed by the processor, so that the device can execute the above processes.

According to one aspect of the present disclosure, a failure factor analysis support system and the like that can support generation of a more accurate failure factor analysis table can be implemented.

The present disclosure is useful for an information processing device or the like that performs failure factor analysis.

What is claimed is:

1. A failure factor analysis support system, comprising:
a text search unit that searches for a text necessary for failure factor analysis of an object from a predetermined database group; and
a failure factor generation unit that generates a first failure factor analysis table based on a search result of the text search unit, wherein
the predetermined database group includes a vector database and a graph database,
the vector database is a database including a latent variable obtained by converting text data, and
the graph database is a database including, as a graph structure, a correspondence between first character strings each including a word of a general expression, a correspondence between second character strings each including a word of a specific expression, and a correspondence between the first character string and the second character string in the text data.

2. The failure factor analysis support system according to claim 1, wherein
the text search unit is configured to execute:
calculating at least one of a first similarity indicating a similarity between a text query given as a search input and a text in the graph database and a second similarity indicating a similarity between a latent variable obtained by converting the text query and a latent variable in the vector database; and
ranking and searching a text in the predetermined database group based on at least one of the calculated first similarity and the calculated second similarity.

3. The failure factor analysis support system according to claim 2, comprising a vectorization unit that extracts a latent variable from text data, wherein
the latent variable extracted by the vectorization unit is a tensor configured to express a point or spread on a latent variable space, and
the text search unit calculates the first similarity based on at least one of an angle of deviation between tensors and a degree of superimposition of spread between tensors calculated from two tensors, and searches for a text necessary for the failure factor analysis using at least the first similarity.

4. The failure factor analysis support system according to claim 3, comprising a granularity adjuster that performs processing of aligning granularities of words used in the first failure factor analysis table using a latent variable obtained from a text of the first failure factor analysis table and a tensor in the latent variable space.

5. The failure factor analysis support system according to claim 1, comprising a relation extractor that constructs the graph database, wherein
the relation extractor is configured to execute, using a model that extracts a relationship between units of semantics each including a word or a character string including a word:
constructing a general-purpose graph database in which a unit of semantics is constructed only from the first character string and a dedicated graph database including the second character string; and
constructing the graph database by extracting a relationship of units of semantics between the general-purpose graph database and the dedicated graph database.

6. The failure factor analysis support system according to claim 1, wherein when a text query given as a search input includes non-text data including at least one of an image, a moving image, a 3D model, and an animated 3D model of a product or a manufacturing device that is the object, the text search unit searches for a necessary text from the predetermined database group using a latent variable obtained by converting at least one of a description text of the non-text data or the non-text data.

7. The failure factor analysis support system according to claim 1, wherein the vector database includes at least one of a latent variable obtained by converting a description text of non-text data including at least one of an image, a moving image, a 3D model, and an animated 3D model, and a latent variable obtained by converting the non-text data.

8. The failure factor analysis support system according to claim 1, comprising a display editor that edits a display mode of the first failure factor analysis table based on a difference between a second failure factor analysis table acquired from a user and the first failure factor analysis table.

9. The failure factor analysis support system according to claim 8, wherein the display editor edits the display mode so as to highlight a portion indicating the difference in the first failure factor analysis table.

10. The failure factor analysis support system according to claim 1, wherein
an agent unit is configured based on the text search unit and the failure factor generation unit, and
the agent unit inputs a task definition in which a procedure of failure factor analysis and a goal are organized, information indicating a tool group including at least one of the failure factor generation unit, the text search unit, a Web search engine, and a format corrector, and description of how to use the tool group to one or more large language models, thereby acquiring a processing procedure through planning processing that plans an order of a use order of the tool group, and performing failure factor analysis based on the acquired processing procedure.

11. The failure factor analysis support system according to claim 1, comprising a database device that stores the predetermined database group.

12. The failure factor analysis support system according to claim 1, wherein the predetermined database group is a document database that accumulates technical information on the object as text data.

13. A failure factor analysis support method executed by a processor, the failure factor analysis support method comprising:
searching for a text necessary for failure factor analysis of an object from a predetermined database group; and
generating a failure factor analysis table based on a search result, wherein
the predetermined database group includes a vector database and a graph database,
the vector database is a database including a latent variable obtained by converting text data, and
the graph database is a database including, as a graph structure, a correspondence between first character strings each including a word of a general expression, a correspondence between second character strings each including a word of a specific expression, and a correspondence between the first character string and the second character string in text data.

14. A program for causing a computer to execute the failure factor analysis support method according to claim 13.
